(19) United States
(12) Patent Application Publication
(10) Pub. No.: US 2010/0112324 A1
(43) Pub. Date: May 6, 2010

(54) Coatings on Glass

(76) Inventor: Premakaran T. Boaz, Port Orange, FL (US)

Correspondence Address: LEE & HAYES, PLLC, 601 W. RIVERSIDE AVENUE, SUITE 1400, SPOKANE, WA, 99201, US

(21) Appl. No.: 12/684,259

(22) Filed: Jan. 8, 2010

Related U.S. Application Data
(60) Provisional application No. 61/231,929, filed on Aug. 6, 2009.

(51) Int. Cl. B32B 17/06; B05D 3/06; B05C 9/14

(52) U.S. Cl. 428/220; 427/559; 118/641

(57) ABSTRACT

A glass object is heated by application of infrared energy and radio-wave energy. A coating is applied to the glass object and the glass object is subject to additional heating with radio-wave energy. The temperature and duration of the additional heating may be sufficient for a pyrolytic reaction to occur between the coating and the glass object. The coated glass object may be cooled either rapidly to temper the glass or cooled gently to anneal the glass.

### RELATED APPLICATION

This patent application claims the benefit of U.S. Provisional Patent Application No. 61/231,929, filed on Aug. 6, 2009, the entire contents of which are incorporated herein by reference.

### TECHNICAL FIELD

This application generally relates to applying coatings to glass heated with radio-wave energy.

### BACKGROUND

Coatings may be applied to glass surfaces to improve aesthetic or functional characteristics of the glass. Characteristic that can be improved by coatings include color (e.g., for decoration, privacy, etc.), reflectivity (to increase or decrease), energy absorbance (e.g., to prevent heat from entering a car or building), durability (e.g., surface hardening or other protection), ease of maintenance (e.g., self cleaning), and the like. Coating glass is frequently used in the automotive and building industries, but also has many other applications such as in manufacturing photo voltaic cells (e.g., solar panels), glass containers, and the like.

Pyrolytic coatings are one type of coating that may be applied to glass surfaces. During pyrolisis molecules of the coating and the glass are fused together at an elevated temperature creating a strong bond between the glass and the coating. The coating is typically only a few molecules thick and may be one or more layers. Pyrolytic coatings are often applied during the initial manufacture of glass.

Glass, in particular glass panels, may be formed by floating molten glass on top of a liquid metal such as tin. The molten glass spreads evenly over the liquid metal into a flat sheet. This is known as a float process. A ribbon of glass exiting the liquid metal bath may be coated with the pyrolytic coating. Pieces of coated glass of desired sizes are cut from this continuous ribbon. This process is employed when a high volume of the coated glass is needed. If a lower volume of coated glass is needed, precut pieces of glass may be individually heated to a temperature suitable for a pyrolytic reaction and then coated with the pyrolytic coating.

Further finishing of glass, both coated and uncoated, may include tempering, shaping and/or annealing the final glass product. Tempering involves rapidly cooling heated glass such that the inside of the glass is relatively hot compared to the outer surfaces of the glass. This creates balanced internal stresses within the glass that strengthens the glass and increases the amount of force that must be applied before the glass fractures. Tempering also causes the glass to fracture into small pieces rather than shards when the glass does fracture. Annealing is another technique for increasing the durability of glass. However annealing involves cooling the glass at a slower rate than for tempering in order to relieve rather than create internal stresses.

Even though pyrolysis requires elevated temperatures, the temperature at which glass leaves the liquid metal bath and/or the temperature necessary for tempering or annealing glass may damage pyrolytic coatings. The temperature inside most furnaces used to heat glass is too high to apply pyrolytic coatings. Accordingly, there is a need in the art for improvements in methods and apparatus for applying pyrolytic coatings to glass.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This application generally relates to applying coatings to glass. In one example, a glass object, such as a glass panel, is initially heated to a first temperature by a heat source producing infrared energy. The glass object is heated further to a second, higher temperature with radio-wave energy. A coating, for example a pyrolytic coating, is applied to the glass object. The glass object is re-heated with radio-wave energy to a third temperature. Next, the glass object is cooled to a fourth temperature either for tempering or annealing.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an illustrative apparatus for heating glass.

FIG. 2 is a schematic cross-sectional view of glass passing through the apparatus of FIG. 1, taken along line A-A in FIG. 1.

FIG. 3 is a graph of temperature during different phases of an illustrative process for coating glass.

FIG. 4 is an illustrative flow diagram of a process for applying coatings to glass.

### DETAILED DESCRIPTION

The following description sets forth example implementations of devices and processes for applying coatings to glass. Coatings applied to glass may be pyrolytic coatings, but may also include “staining” coatings such as copper and silver chlorides that result in ionic penetration of the glass surface to change surface colors, powders or slurry of colored or clear low melting glass generally known as “ceramic” coatings, and/or the like. Additionally, “nano” particles as well as flakes of metals are examples of other types of materials that may be applied as a coating to a glass surface. The implementations are described with specificity in order to meet statutory requirements. However, the description itself is not intended to limit the scope of this patent. Rather, the inventor has contemplated that the claimed subject matter might also be embodied in other ways, to include different elements or combinations of elements similar to the ones described in this document, in conjunction with other present or subsequently developed technologies.

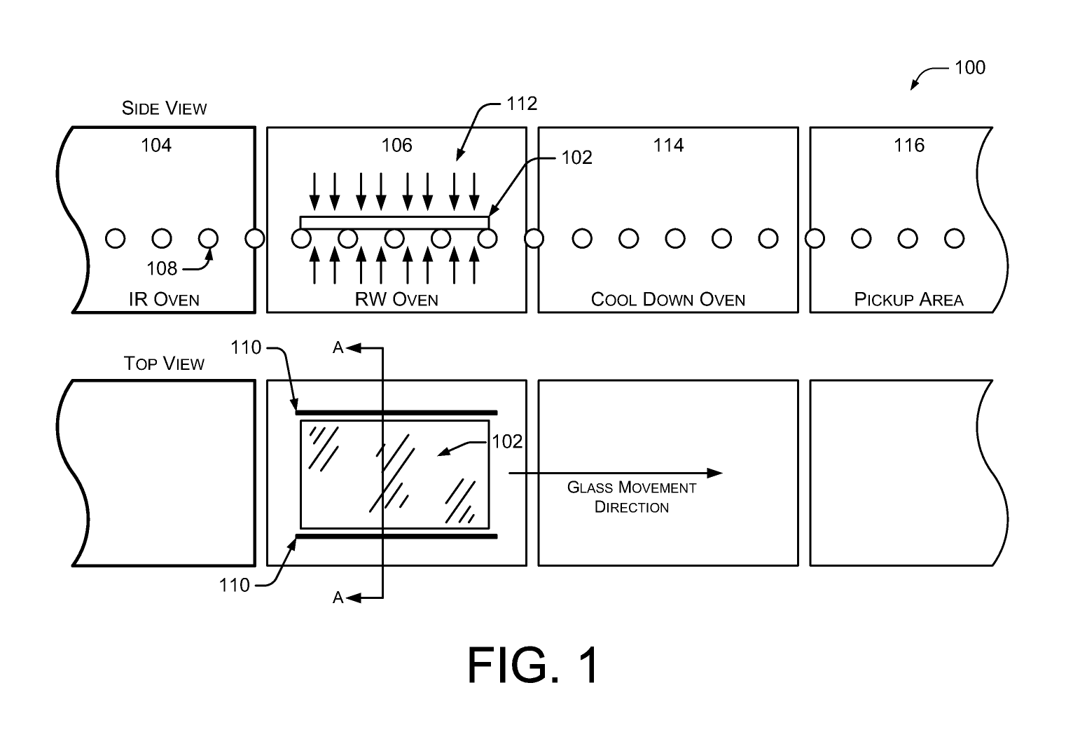

FIG. 1 shows a side view and a top view of an apparatus 100 comprising a series of chambers for use in applying coatings to glass. A glass panel 102 may enter the apparatus 100 from the left side of FIG. 1 into an infrared (IR) oven 104. The piece of glass 102 may be a newly formed flat glass panel from a liquid metal bath (not shown), newly formed glass made by another process, a previously manufactured glass object, or the like. The IR energy may be generated by a gas burner, electric element, or the like. The IR oven 104 may generate temperatures of several hundred degrees Celsius, so the IR oven 104 may be an enclosed and insulated chamber or furnace, such as a lehr, that can maintain internal temperatures significantly higher than the ambient temperature of the surrounding environment.

The IR oven 104 raises a temperature of the glass panel 102 to a temperature at which the glass becomes receptive to radio-wave (RW) energy. The temperature at which glass becomes receptive RW energy is generally around the softening temperature of the glass. With soda lime glass, for example, this “RW receptivity temperature” is around 500° C. to 600° C. Below this temperature, such as at room temperature, glass is transparent to (i.e., does not absorb) RW energy due to the dielectric properties of glass. For other types of glass this temperature may be different.

As mentioned above, RW energy absorbance depends on the dielectric properties of the composition of the glass with respect to change in temperature. At or above the RW receptivity temperature, the temperature of the glass increases in response to absorbing RW energy. Below this temperature RW energy does not cause the glass to heat up. Thus, the glass panel 102 is pre-heated with IR energy, or another form of energy, before application of RW energy.

The glass panel 102 is moved from the IR oven 104 to an RW oven 106. The RW oven 106 may be immediately adjacent to the IR oven 104 in order to minimize cooling of the glass during transfer. In some implementations, the glass panel 102 may be moved through apparatus 100 on ceramic rollers 108 that support the glass panel 102 on multiple ceramic rings spaced across the ceramic rollers. Other roller materials besides ceramics, and other mechanisms for transporting the glass panel 102 besides rollers, are also possible. Within the RW oven 104, the glass panel 102 is heated with RW energy. In one implementation, the glass panel 102 may be located in between multiple RW electrodes 110. In some implementations, the RW electrodes 110 may be the same or similar to electrodes used for moisture extraction application in food and paper processing industries. The RW electrodes 110 may be made of non-ferric and non-magnetic metal. In some implementations, the RW electrodes 110 may comprise aluminum electrodes and plastic components such as nylon. In these implementations, the high heat of the IR oven 104 may damage the RW electrodes 110. Two RW electrodes 110, the positive and the negative, may be placed close to the glass panel 102 and across the width of the glass panel 102 in order to provide maximum exposure to the RW field that exists between the two electrode terminals. The RW electrodes 110 may create electromagnetic radiation with wavelengths that are generally characterized as radio waves or microwaves. This portion (i.e., radio and microwave) of the electromagnetic spectrum generally includes waves having a wavelength from about one kilometer (100 kilohertz) to about one centimeter (30 gigahertz). In some implementations, a frequency of the radio waves may be between about 1 megahertz and about 500 megahertz. For example, a frequency of the electromagnetic radiation created by the RW electrodes 110 may be a frequency that does not interfere with other radio transmissions such as communications signals. In several specific implementations, the frequency may be selected from, but is not limited to, about 20 megahertz, about 90 megahertz, or about 0.4 gigahertz. Because RW energy only heats the glass itself rather than the entire RW oven 106, the RW oven 106 may be at or near ambient temperature unlike the IR oven 104.

The glass panel 102 may pass through a significant temperature differential when moving from the IR oven 104 to the RW oven 106. The leading end of the glass panel 102 may lose much of its temperature in the RW oven 106 before the trailing end is out of the IR oven 104. This loss of temperature is greater for thin sheets of glass such as sheets with a thickness of less than 3 millimeters. Controlling the temperature of the glass is important because relatively small changes in temperature can have a large effect on viscosity (e.g., a change from 600° C. to 700° C. can lead to a 1000-fold decrease in viscosity). Thus, is beneficial to control the temperature of the class during application of pyrolytic coatings. In some implementations, this temperature differential may be compensated for by positioning the RW electrodes 110 to heat the leading portion of the glass panel 102 at a higher rate than the trailing portion.

The high-frequency RW energy may heat up the glass panel 102 to a temperature which enhances a pyrolytic reaction between the glass panel 102 and a coating. The coating may comprise a metal oxide or a silicon oxide. For example the coating may comprise ZnO₂, SnO₂, Sb₂O₃, TiO₂, Co₃O₄, Cr₂O₃, SiO₂, and/or mixtures thereof. However, any other material which may be applied to heated glass, such as through spray nozzles, is also envisioned within the scope of this disclosure. For example, nanomaterials (i.e., smaller than a one tenth of a micrometer in at least one dimension) may also be applied through this process. The pyrolytic reaction temperature may vary with the chemical composition of the coating material and the type of glass. Generally the pyrolytic reaction temperature is between about 610° C. and about 650° C. In some implementations, the pyrolytic reaction temperature may be slightly below the temperature at which the glass begins to deform, for example about 630° C. for some types of glass. When the glass panel 102 is at the pyrolytic reaction temperature the coating material may be applied to the glass panel 102. The coating material, either in a vapor state or suspended in a solvent medium, may be sprayed onto the hot glass surface by spray nozzles 112. Other non-contact application procedures may also be used to apply the coating material to the hot glass.

Since the RW oven 106 may be maintained at or near ambient temperature it is possible for the glass panel 102 to remain stationary in the RW oven 106 for both RW heating and application of the coating. Thus in some implementations, the RW oven 106 is a single section of apparatus 100 in which both heating and coating occur. In some implementations, during the spray process, the RW electrodes 110 may be turned off to prevent arcing. For example, the RW electrodes 110 may be successively turned off and later turned back on during multiple cycles of coating and heating.

During the spray process the glass panel 102 may cool down both because the application of the coating may have a cooling effect and because the RW electrodes are turned off. The glass panel 102 may cool below the pyrolytic reaction temperature. Subsequent re-heating with RW energy may return the glass panel 102 to the pyrolytic reaction temperature to bond fully the coating with the surface of the glass by providing an additional few seconds of heating in order for the bonding to take place. This may be done in the same chamber without moving the glass panel 102 to another chamber such as furnace. The glass panel 102 may remain stationary within the RW Oven 106 or, in some implementations, the glass panel 102 may be oscillated within the RW Oven 106. Oscillation may provide more uniform application of the coating because the glass panel 102 is moving relative to the spray nozzles 112. An oscillation distance may be based upon spacing of the spray nozzles 112, for example the oscillation distance may be the same as the distance between spray nozzles 112, approximately half the distance between spray nozzles 112, or some other distance. In some implementations, oscillation distance may be a few centimeters.

Conventional methods for applying pyrolytic coatings to glass require moving the glass back and forth between a furnace and a spray chamber. The distance required to move the glass between separate chambers is much larger, for example several meters, than the oscillation distance. Moving glass, particularly glass at or near its softening temperature, may introduce undesirable optical distortions in the glass. Larger movements may be more likely to distort the glass.

The RW oven 106 may also be equipped with air nozzles to temper the glass panel 102 by applying an air quench that rapidly cools the glass panel 102. Quenching with other gases that have a higher specific heat capacity than air, for examples steam, is also possible. In this implementation, the RW heating, coating, and tempering can all happen in the same location without moving the glass panel 102. Alternatively the glass panel 102 may be moved to another location such as a cool down oven 114 for the air quench. However, a delay of a few seconds during transit may cause the glass to become too cold for proper tempering. Completing all these steps in the same place can save space as compared to other apparatus for applying pyrolytic coatings to glass. Minimizing movement of the glass panel 102 while hot can also reduce distortion of the glass panel 102 particularly for thin glass panels. For glass that is thinner than about 3 millimeters, a decrease in viscosity does not lag an increase in temperature. Thus, heating thin glass quickly and moving the glass before viscosity drops is not practical for glass less than about 3 millimeters thick. Therefore this process is particularly beneficial to thin glass because the glass may be heated and the coating applied without transferring the glass between ovens or spray chambers.

Additionally or alternatively, the glass panel 102 may be moved to the cool down oven 114 for an annealing step. The cool down oven 114 may include air nozzles and/or IR heating elements to control the rate at which the glass panel 102 cools. Quenching of the hot glass, both in the RW oven 106 and/or the cool down oven 114, may be performed by methods other than air quenching.

Finally, the glass panel 102 may be moved to the last section of apparatus 100, the pickup area 116, where the glass panel 102 may be unloaded from apparatus 100 or directed to another apparatus for further processing such as cutting or polishing As discussed earlier, the RW oven 106 may be at or near ambient temperature, so in some implementations the RW oven 106 may also function as the cool down oven 114 and the pickup area 116.

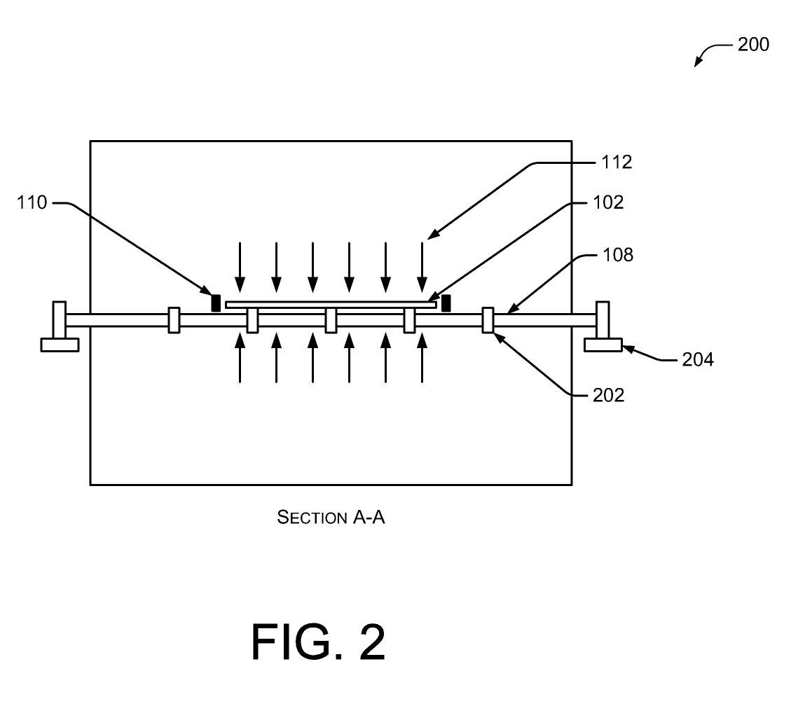

FIG. 2 shows a cross-sectional view 200 of FIG. 1 taken across the line A-A in the RW oven 106 in FIG. 1. In this illustrative example, the glass panel 102 is located between two RW electrodes 110. The roller apparatus 108 supports the glass panel 102 between spray nozzles 112. The spray nozzles 112 are shown both above and below the glass panel 102. However, the spray nozzles 112 may alternatively be located on only one side of the glass panel 102. The rings 202 and the rollers 108 (not shown in the top view) may be positioned to allow free flow of air both above and below the glass panel 102. The free flow of air is beneficial for the air quench. The rollers 108 may be turned by a chain 204 or similar mechanism. As discussed above, the glass panel 102 may be oscillated within the RW oven 106. For glass that has softened due to heating, oscillation may prevent the rings 202 from leaving marks in the soft glass.

While the process is explained as it applies to a flat glass panel, the same process steps may be applied to other glass articles such as curved panels, containers, and decorative items in a variety of shapes other than flat panels.

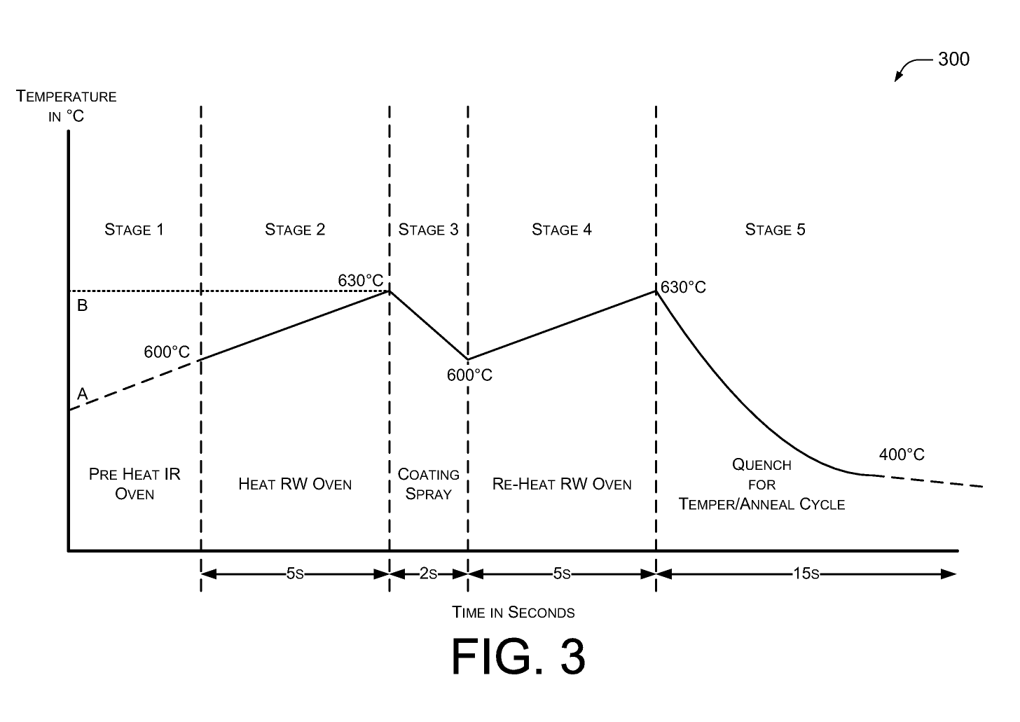

FIG. 3 shows a graph 300 of the glass temperature/time relation during heating and application of a coating. For implementations in which the glass panel 102 starts at a relatively cool temperature such as ambient temperature, Stage 1 shows heating the glass panel 102 within the IR oven 106 up to the radio-wave receptivity temperature along line A. As discussed above, the radio-wave receptivity temperature may be from about 500° C. to about 600° C. for soda lime glass. High silica glass may have a higher radio-wave receptivity temperature and high lead glass may have a lower radio-wave receptivity temperature.

The length of time for Stage 1 will vary depending on an initial starting temperature of the glass panel 102 and the radio-wave receptivity temperature. In implementations where the glass panel 102 comes from a molten metal float or a glass object of a different shape comes from a mold process, the glass may already be around 630° C. In such implementations, stage 1 may be shortened or omitted. The temperature profile of glass in this case is indicated by line B in FIG. 3.

In Stage 2 the glass panel 102 is heated up to the pyrolytic reaction temperature using RW energy. Stage 2 takes about 5 seconds assuming a pyrolytic reaction temperature of about 630° C. In implementations where the glass panel 102 is already at or near the pyrolytic reaction temperature, such as when the glass panel 102 was recently formed on a molten metal float, Stage 2 may be shortened or omitted. The RW oven 106 may apply RW energy to the glass panel 102 in order to compensate for any heat loss during transferred from the molten metal bath to the RW oven 106. Since the RW oven 106 may be at ambient or room temperature, once the RW electrodes 110 are turned off, the glass panel 102 begins to cool. Application of the coating material further cools the glass panel 102.

Stage 3 shows the glass cooling down to about 600° C. as a result of turning off the RW electrodes 110 and spraying the glass panel 102. This may happen in about 2 seconds. In some implementations, the RW electrodes 110 are turned on when the atmosphere in the RW oven 106 is relatively clean air free from particulates such as the coating material. In other implementations, the RW electrodes 110 may remain on while the coating material is sprayed onto the glass panel 102. This may prevent cooling of the glass panel 102; however, doing so may cause arcing because the coating material is exposed to the radio-wave energy as it is sprayed. The arcing may potentially damage the apparatus 100.

In stage 4 the glass panel 102 may be re-heated with RW energy. In implementations where the RW electrodes 110 and the spray nozzles 112 are in the same chamber or oven, such as RW oven 106, the re-heating may occur without moving the glass panel 102. The re-heating in Stage 4 may bond the coating material to the hot surface of the glass panel 102. The glass panel 102 may be re-heated in Stage 4 to approximately the same temperature as the pyrolytic reaction temperature, for example 630° C., as shown in graph 300. In other implementations, Stage 4 may heat the glass 102 to a different temperature for example when a different coating material with a different pyrolytic reaction temperature is applied on top of the first coating material. The re-heating may take about 5 seconds depending on the extent of cooling during application of the pyrolytic coating.

In Stage 5 the glass panel 102 may be cooled. The glass panel 102 may be cooled rapidly to temper the panel. Alternatively, a gentle cooling cycle may be used to annealing the glass panel 102. The length of Stage 5 will depend on the type of cooling (i.e., tempering or annealing) that is desired and the heat capacity of the glass panel 102. In some implementations, it may take approximately 15 seconds or longer for the glass panel 102 to cool to a temperature (e.g., 400° C.) at which movement will not introduce distortions into the glass because viscosity of the glass increases such that the glass is rigid enough to withstand handling.

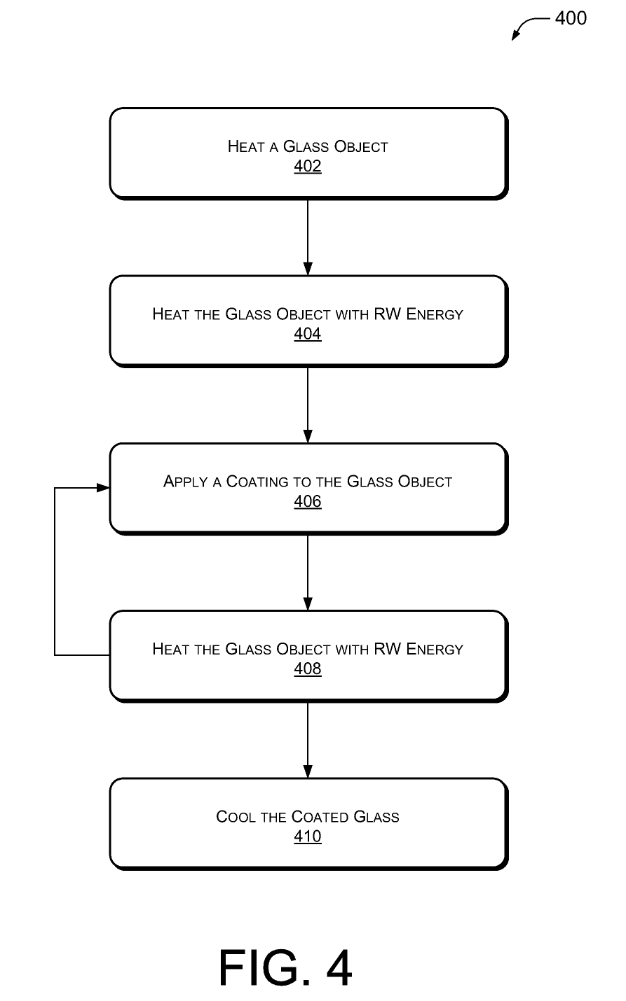

FIG. 4 shows illustrative process 400 for applying a coating to glass. For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the process, or an alternate process. Moreover, it is also possible that one or more of the provided operations may be modified or omitted.

At block 402, a glass object is heated. As discussed above, this heating may be achieved with IR energy in the IR oven 104. Alternatively, the glass object may be heated by energy other than IR energy. The heating in block 402 may be sufficient to make the glass object receptive to RW energy.

At block 404 the glass object is heated with RW energy. The RW energy may be applied by the RW electrodes 110 in the RW oven 106. The heating at block 404 may heat the glass object to a temperature at which a coating will pyrolytically bond with the glass object. In implementations where heating at block 402 raises the temperature of the glass object to the pyrolytic reaction temperature, block 404 may be omitted from process 400.

At block 406, a coating is applied to the glass object. As discussed above, the coating may be a metal oxide, a silicon oxide, or the like. The application may include spraying the coating onto the glass object with spray nozzles 112 inside the RW oven 106. In some implementations, this may be the final step of process 400. For example, after applying the coating the glass object may be allowed to cool gradually to ambient temperature after block 406.

At block 408, the glass object may be heated again with RW energy. This second heating with RW energy may be used to bond the coating material with the glass object. Process 400 may return to block 406 to apply a second coating to the glass object. Further applications of coatings and heating with RW energy may be repeated to apply any number of coating layers onto the glass object.

At block 410, the coated glass object is cooled. The glass object may be air quenched to rapidly cool and temper the glass. Alternatively, the glass object may be cooled gradually to anneal the glass.

Although the subject matter of this disclosure has described in language specific to structural features and/or methodological steps, the subject matter defined in the appended claims is not necessarily limited to the specific features or steps described. Rather, the specific features and steps are disclosed as preferred forms of implementing the claimed invention.

1. A method for applying a coating to a glass object, the method comprising:
heating the glass object to a first temperature;
heating the glass object to a second temperature with radio-wave energy;
applying a coating to the glass object;
heating the glass object to a third temperature with radio-wave energy; and
cooling the glass object to a fourth temperature.

2. The method of claim 1, wherein the glass object comprises a substantially flat glass panel with a thickness of about 3 mm or less.

3. The method of claim 1, wherein the first temperature is at or above a radio wave receptivity temperature, at which a temperature of the glass object will increase in response to absorbing radio-wave energy.

4. The method of claim 1, wherein the first temperature is between about 500° C. and about 620° C.

5. The method of claim 1, wherein the radio-wave energy comprises radio-waves with a frequency of between about 1 megahertz and about 500 megahertz.

6. The method of claim 5, wherein the radio-wave energy comprises radio-waves with a frequency of between about 10 megahertz and about 30 megahertz.

7. The method of claim 1, wherein the second temperature is at or above a temperature at which a pyrolytic reaction occurs between the glass object and the coating.

8. The method of claim 1, wherein the second temperature is between about 610° C. and about 650° C.

9. The method of claim 1, wherein the coating comprises a metal oxide or a silicon oxide.

10. The method of claim 1, wherein the third temperature is approximately the same as the second temperature.

11. The method of claim 1, wherein the cooling comprises cooling at a predetermined rate to temper the glass object.

12. The method of claim 1, wherein the cooling comprises cooling at a predetermined rate to anneal the glass object.

13. The method of claim 1, wherein the fourth temperature is a temperature at which the glass object solidifies.

14. The method of claim 1, wherein the glass object remains stationary or oscillates during the heating the glass to the second temperature, the applying the coating to the glass object, and the heating the glass object to the third temperature.

15. The method of claim 1, further comprising:
applying a second coating to the glass object; and
heating the glass object with radio-wave energy to or above a fifth temperature at which a pyrolytic reaction occurs between the glass object and the second coating.

16. An apparatus comprising:
a radiowave oven comprising:
radio-wave electrodes positioned across the width of a glass object to heat the glass object to a reaction temperature at which a reaction occurs between the glass object and a coating material; and
spray nozzles facing at least one surface of the glass object to apply the coating material onto the glass object, the spray nozzles located proximate to the radio-wave electrodes.

17. The apparatus of claim 16, wherein the radiowave oven further comprises air jets to cool the glass object at a predetermined rate.

18. The apparatus of claim 16, further comprising an infrared oven including an infrared energy source to heat the glass object to a radio-wave receptivity temperature at which exposure to radio-wave energy further increases a temperature of the glass object.

19. A coated glass panel comprising:
a glass layer tempered by an initial heating with infrared energy followed by a further heating with radio-wave energy and a cool down at a rate sufficient to temper the glass layer;
a pyrolytic coating bonded to the glass layer by the further heating with radio-wave energy, the further heating at a temperature and for a duration sufficient to bond the pyrolytic coating to the glass layer; and
wherein a thickness of the glass panel is less than about 3 mm.

20. The glass panel of claim 19, wherein the thickness of the glass panel is less than about 2 mm.
